(19) United States
(12) Patent Application Publication
(10) Pub. No.: US 2012/0109796 A1
(43) Pub. Date: May 3, 2012

(54) Taxi Service Control System

(76) Inventors: Roy Mashal, Ramat Hasharon (IL); Ami Krispel, Ramat Gan (IL)

(21) Appl. No.: 12/916,550

(22) Filed: Oct. 31, 2010

(51) Int. Cl. G06Q 30/00; G06F 17/00

(52) U.S. Cl. 705/34; 235/384

(57) ABSTRACT

Apparatus for taxi service controlling, the apparatus comprising: a token data reader, installed in a vehicle of a fleet, configured to read token data from a machine readable medium provided by a passenger, and a vehicle data communicator, in communication with the token data reader, configured to communicate the read token data to a remote server of an operator of the fleet, and to receive billing data based at least on the token data, from the remote server.

### FIELD AND BACKGROUND OF THE INVENTION

The present invention relates to a taxi service and, more particularly, but not exclusively to a system and a method for taxi service controlling.

Taxi services have become one of the most popular means of public transportation, especially in big cities like London, New-York City, Tokyo or Berlin.

For example, by 2010, the number of taxies in New-York City alone has reached 13,000 with over 40,000 licensed taxi drivers.

Throughout the years, control of taxi services has remained dependent on a combination of human control by taxi dispatchers who communicate vocally with taxicabs, using a phone line or a two-way radio connection, and taximeters installed in the taxicabs.

A taximeter is a mechanical or electronic device installed in a taxicab. The taximeter is used for controlling rides and billing the taxicab's passengers.

The taximeter calculates passenger fares based on a combination of distance traveled and waiting time, as known in the art.

Typically, the taximeter repeats cyclically through the main stages of a) Free (in which the taxicab is free), b) Start (in which the taxicab starts a ride), c) end (in which a passenger reaches his destination).

Typically, upon reaching the destination, the taxi driver bills the passenger for the ride, and prints an invoice using a small printer attached to the taximeter.

Once the passenger is billed, the passenger pays for the ride. Finally, the taxi driver pushes a button on the taximeter, which returns the taximeter to stage a).

Advancement in taxi service control has included changes in mechanical and electrical operation of taximeters.

For example, US Publication No. 20020049683, to Claude, published on Apr. 5, 2002, entitled “Process for preventing frauds with regard to a taxi equipped with an electronic taximeter”, describes a process for preventing frauds with regard to a taxi equipped with an electronic taximeter, by detecting occurrence of a disconnection of a printing head of a printer of a taximeter.

U.S. Pat. No. 4,024,384, to Tateishi et al., filed on Mar. 24, 1975, entitled “Modification in electronic taximeter”, describes a modification effective for use in an electronic taximeter, through the introduction of an ability to electrically compensate for variations in distance traveled per a predetermined number of degrees of revolutions of wheels of a vehicle, in accordance with different makes and models of the vehicle.

U.S. Pat. No. 3,953,720, to Kelch, filed on Jun. 25, 1974, entitled “Electronic taximeter for taxis taking a plurality of passengers on overlapping trips”, describes a taxicab provided with an electronic taximeter which includes fare computing circuitry operative for separately computing the fares of a plurality of passengers whose respective trips overlap.

### SUMMARY OF THE INVENTION

According to one aspect of the present invention, there is provided an apparatus for taxi service controlling, the apparatus comprising: a token data reader, installed in a vehicle of a fleet, configured to read token data from a machine readable medium provided by a passenger, and a vehicle data communicator, in communication with the token data reader, configured to communicate the read token data to a remote server of an operator of the fleet, and to receive billing data based at least on the token data, from the remote server.

According to a second aspect of the present invention, there is provided a computer implemented method for taxi service controlling, the method comprising steps the computer is programmed to perform, the steps comprising: in a vehicle of a fleet, reading token data from a machine readable medium provided by a passenger, communicating the read token data to a remote server of an operator of the fleet, and receiving billing data based at least on the token data, from the remote server.

According to a third aspect of the present invention, there is provided an apparatus for taxi service controlling, implemented on a server of an operator of a vehicle fleet, the apparatus comprising: a data receiver, configured to receive token data of a passenger from a vehicle remote from the server of the vehicle fleet, a billing data generator, in communication with the data receiver, configured to generate billing data based at least on the received token data, and a server data communicator, in communication with the billing data generator, configured to communicate the generated billing data to the vehicle remote from the server.

According to a fourth aspect of the present invention, there is provided a method for taxi service controlling, implemented on a server of an operator of a vehicle fleet, the method comprising steps the server is programmed to perform, the steps comprising: receiving token data of a passenger from a vehicle remote from the server of the operator of the vehicle fleet, generating billing data based at least on the received token data, and communicating the generated billing data to the vehicle remote from the server.

According to a fifth aspect of the present invention, there is provided a system for taxi service controlling, the system comprising: a token data reader, installed in a vehicle of a fleet, configured to read token data from a machine readable medium provided by a passenger, a vehicle data communicator, in communication with the token data reader, for receiving the read token data, a data receiver, implemented on a server of an operator of the fleet, in remote communication with the vehicle data communicator, for receiving the token data, a billing data generator, configured to generate billing data, based at least on the received token data, and a server data communicator, configured to communicate the generated billing data to the vehicle data communicator.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof.

Moreover, according to actual instrumentation and equipment of preferred embodiments of the method and system of the present invention, several selected steps could be implemented by hardware or by software on any operating system of any firmware or a combination thereof.

For example, as hardware, selected steps of the invention could be implemented as a chip or a circuit. As software, selected steps of the invention could be implemented as a plurality of software instructions being executed by a computer using any suitable operating system.

In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings.

With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. The description taken with the drawings makes apparent to those skilled in the art how several exemplary forms of the invention may be embodied in practice.

In the drawings:

FIG. 1 is a block diagram schematically illustrating a first apparatus for taxi service controlling, according to an exemplary embodiment of the present invention.

FIG. 2 is a block diagram schematically illustrating a second apparatus for taxi service controlling, according to an exemplary embodiment of the present invention.

FIG. 3 is a block diagram, schematically illustrating a first system for taxi service controlling, according to an exemplary embodiment of the present invention.

FIG. 4 is a block diagram, schematically illustrating a second system for taxi service controlling, according to an exemplary embodiment of the present invention.

FIG. 5 is a block diagram, schematically illustrating a third system for taxi service controlling, according to an exemplary embodiment of the present invention.

FIG. 6 is a flowchart illustrating a first method for taxi service controlling, according to an exemplary embodiment of the present invention.

FIG. 7 is a flowchart illustrating a second method for taxi service controlling, according to an exemplary embodiment of the present invention.

FIG. 8 is a flowchart illustrating a third method for taxi service controlling, according to an exemplary embodiment of the present invention.

FIG. 9 is a flowchart illustrating a fourth method for taxi service controlling, according to an exemplary embodiment of the present invention.

FIG. 10 is a flowchart illustrating a fifth method for taxi service controlling, according to an exemplary embodiment of the present invention.

FIG. 11 is a flowchart illustrating a sixth method for taxi service controlling, according to an exemplary embodiment of the present invention.

### DESCRIPTION OF THE PREFERRED EMBODIMENTS

The present embodiments comprise systems, apparatuses and methods for taxi service controlling.

With a system according to an exemplary embodiment of the present invention, taxi service control in general, and billing of taxi services in particular, is carried out from a server in remote communication with an apparatus installed in a vehicle, such as a taxicab, or any other vehicle which carries passengers for a fare.

Currently used billing and payment procedures are based on manual invoicing carried out through operations performed by a driver in his vehicle. The current procedures may also be based on fare data automatically generated by a taximeter installed in the vehicle, on a fixed price the driver reads from a printed table, or on an arbitrary price set by the driver.

According to an exemplary embodiment of the present invention, a computer server (also referred to hereinbelow as a server) in remote communication with a fleet of vehicles, say vehicles used for a taxi service, may be used to control the taxi service in general, and the taxi service's billing processes in particular.

An apparatus implemented on the server of an operator of a fleet, receives token data read in a vehicle of the fleet. The token data may include a secret PIN (Personal Identification Number) read from a machine readable medium (such as a magnetic card or a smart card), data extracted from a barcode printed on a paper or on a plastic card, etc.

The apparatus generates billing data based at least on the token data, and sends the billing data to the vehicle.

Of special interest is an example in which the apparatus is used to control subscription based taxi services.

In one example, a company or another institution subscribed to the taxi service, receives magnetic cards imprinted with token data, say a secret PIN assigned to the company in general or to each of the magnetic cards specifically.

At a start of a taxi ride in a taxicab of the taxi service's vehicle fleet, a passenger who is an employee of the subscribed company gives one of the magnetic cards to the taxi driver. The taxi driver slides the magnetic card into a token data reader, say a magnetic card reader.

The token data reader reads the token data from the magnetic card, and the token data is communicated to a remote server of the operator of the taxi service and fleet.

On the remote server, the token data is verified as authentic, and the subscriber (i.e. company) is verified as active. Consequently, a signal allowing the ride is communicated to the vehicle, and the driver takes the passenger to his destination.

Upon arrival at the destination, the driver slides the magnetic card into the token data reader again. Consequently, the token data is read and communicated to the remote server. Optionally, additional data such as fare data generated by a taximeter or GPS location data generated by a GPS receiver is also forwarded to the remote server.

Using the token data, billing data is generated on the remote server, and sent to the vehicle where a receipt may be printed, say using a small printer attached to a taximeter or to a PDA (Personal Digital Assist), as described in further detail hereinbelow.

The principles and operation of a system, apparatuses, and methods, according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings.

The invention is capable of other embodiments or of being practiced or carried out in various ways. Also, it is to be understood that the phraseology and terminology employed herein is for the purpose of description and should not be regarded as limiting.

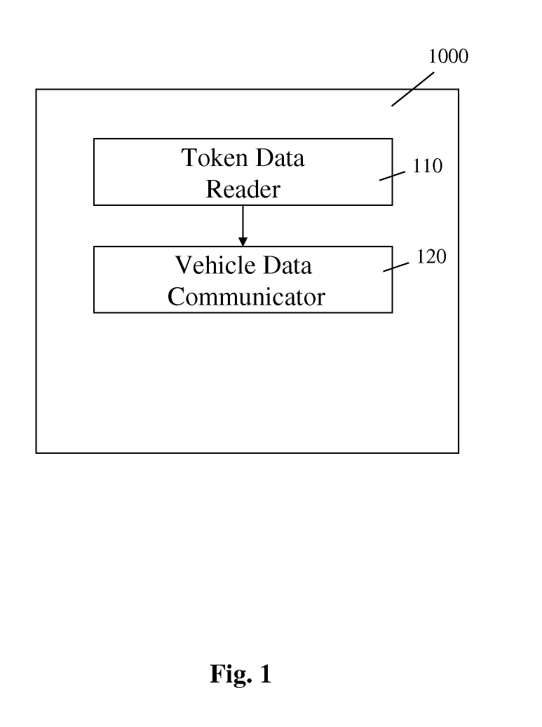

Reference is now made to FIG. 1, which is a block diagram schematically illustrating a first apparatus for taxi service controlling, according to an exemplary embodiment of the present invention.

An exemplary apparatus 1000 is installed in a vehicle of a fleet, say a taxi of a taxi service fleet, or any other vehicle used to carry passengers for a fare.

The apparatus 1000 includes a token data reader 110, installed in the vehicle.

The token data reader 110 may be implemented as hardware (say a magnetic card reader), as software, or as a combination of software and hardware.

The token data reader reads token data from a machine readable medium provided by a passenger who boards the vehicle and wishes to be taken to a certain destination.

Optionally, the token data is a secret PIN (Personal Identification Number), an encrypted number identifying the passenger or the passenger's employer, etc.

The machine readable medium may include, but is not limited to: a magnetic card imprinted with the token data, a smart card storing the token data in an encrypted format, a USB memory storing the token data in an encrypted format, a plastic card bearing the token data in a barcode format, a paper on which the token data is printed in a barcode format, etc.

Optionally, the machine readable medium is a card provided by a taxi service operator to a company which subscribes to the taxi service, and the company gives the card to a company employee or to an ad hoc user, as described in further detail hereinbelow.

Optionally, the machine readable medium is a prepaid card, as known in the art. In one example, the prepaid card is provided by a taxi service operator to a company which subscribes to the taxi service and the company dispatches the card to a company employee or to an ad hoc user, as described in further detail hereinbelow.

Optionally, the machine readable medium is a paper form given to the passenger by his employer (i.e. a company), for a single use, and the token data is also limited to a single use.

Optionally, the token data identifies a subscriber of a taxi service (say a company the passenger works for, or the passenger himself), as described in further detail hereinbelow.

Optionally, the token data is a part of credit card data, say a PIN (Personal Identification Number) imprinted on a magnetic strip of a credit card, additional data imprinted on the magnetic strip, or both.

Apparatus 1000 further includes a vehicle data communicator 120, in communication with the token data reader 110.

The vehicle data communicator 120 communicates the read token data to a remote server, say to a remote server in use by an operator of the taxi service and fleet, as described in further detail hereinbelow.

The token data is used on the remote server, for generating billing data for the passenger (or the company the passenger works for), as described in further detail hereinbelow.

Optionally, the billing data is based at least on the token data.

Optionally, the billing data is further based on information gathered in a preliminary stage, in which the passenger (or his employer) subscribes to the taxi service and provides information such as addresses, bank account details, etc., to the taxi service's operator, as described in further detail hereinbelow

The vehicle data communicator 120 receives the billing data based at least on the token data, from the remote server.

Optionally, the vehicle data communicator 120 is implemented using a cellular modem, a satellite modem, or any other communication device usable for communicating data from the vehicle to the remote server.

The vehicle data communicator 120 may communicate the token data through one or more networks, including, but not limited to: the internet, a cellular network, a satellite network, etc., or any combination thereof.

Optionally, the billing data provides a basis for issuance of an invoice or a receipt. Consequently, the invoice or receipt is printed in the vehicle, using a small printer installed in the vehicle, as described in further detail hereinbelow.

Optionally, the billing data is a confirmation that the passenger can be billed, which is sent from the remote server, to the vehicle data communicator 120, before the vehicle takes the passenger to a destination, as described in further detail hereinbelow.

Optionally, the billing data is a confirmation that the passenger is billed by a system implemented on the remote server. The confirmation is sent from the remote server to the vehicle data communicator 120, after the vehicle arrives at the destination, as described in further detail hereinbelow.

Optionally, the apparatus 1000 further includes a taximeter.

The taximeter generates fare data, typically based on a combination of distance traveled and waiting time (say time the vehicle spends in traffic jams), as known in the art.

The vehicle data communicator 120 may communicate the generated fare data together with the token data, to the remote server. Optionally, the billing data is further based on the fare data.

Optionally, the apparatus 1000 further includes a computer unit, say a PDA (Personal Digital Assist), which receives fare data from a driver of the vehicle, as described in further detail hereinbelow.

The vehicle data communicator 120 may communicate the fare data received from the driver together with the token data, to the remote server. Optionally, the billing data is further based on the fare data received from the driver.

Optionally, the apparatus 1000 further includes a GPS receiver.

The GPS receiver generates GPS location data, based on signals transmitted by a GPS system, as known in the art.

The vehicle data communicator 120 may communicate the generated GPS location data together with the token data, to the remote server. Optionally, the billing data is further based on the GPS location data.

Optionally, the vehicle data communicator 120 further receives dispatching data from the remote server, and presents the dispatching data to the driver, say using a screen attached to the taximeter or a screen of a PDA (Personal Digital Assist), as described in further detail hereinbelow.

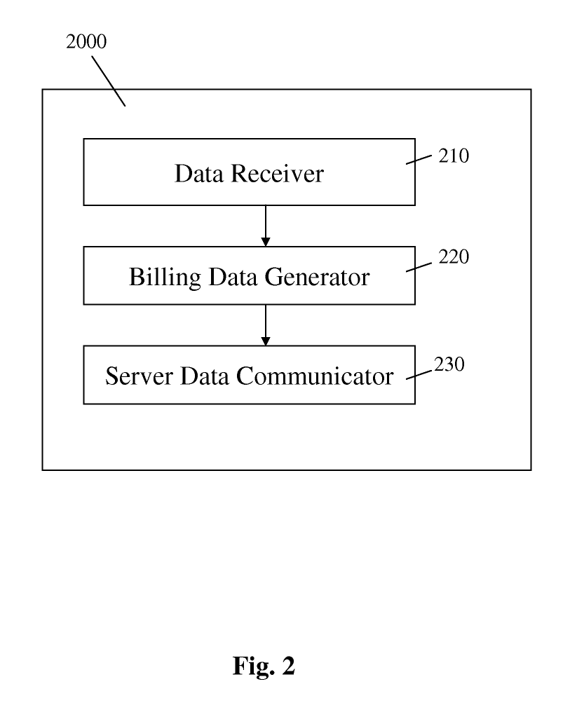

Reference is now made to FIG. 2, which is a block diagram schematically illustrating a second apparatus for taxi service controlling, according to an exemplary embodiment of the present invention.

An exemplary apparatus 2000 is implemented on a server of an operator of a vehicle fleet.

The vehicle fleet may include taxicabs used by the operator, to provide a taxi service, helicopters used by the operator, to provide a helicopter taxi service, or any other vehicles used to carry passengers for a fare.

The server is in remote communication with one or more vehicles of the fleet.

Optionally, the server is a computer installed at a central office of a taxi service operator, which communicates with several taxicabs used by the taxi service, for controlling the taxi service, as described in further detail hereinbelow.

Apparatus 2000 may be implemented as hardware, as software, or as a combination of software and hardware.

The apparatus 2000 includes a data receiver 210.

The data receiver 210 receives token data from a vehicle remote from the server.

Optionally, the data receiver 210 is implemented using a cellular modem, a satellite modem, or any other communication device usable for receiving data communicated from the remote vehicle to the server.

The data receiver 210 may receive the token data through one or more networks, including, but not limited to: the internet, a cellular network, a satellite network, etc., or any combination thereof.

Optionally, the token data is a secret PIN (Personal Identification Number), an encrypted number identifying a passenger in the vehicle or the passenger's employer, etc.

Optionally, the token data identifies a subscriber of a taxi service (say a company the passenger works for, or the passenger himself), as described in further detail hereinbelow.

Optionally, the token data includes data read from a machine readable medium, in the vehicle, as described in further detail hereinabove.

Optionally, the token data may include a part of credit card data, say a PIN (Personal Identification Number) imprinted on a magnetic strip of a credit card, additional data imprinted on the magnetic strip, or both, as described in further detail hereinabove.

Apparatus 2000 further includes a billing data generator 220, in communication with the data receiver 210.

The billing data generator 220 generates billing data based at least on the received token data.

In one example, the data receiver 210 receives the token data before the passenger is taken to the passenger's destination. The billing data generator 220 verifies that the token data belongs to a subscriber of the taxi service, that the subscriber is not blocked due to credit problems, that the passenger's credit card is not blocked, etc.

Upon successful verification, the billing data generator 220 generates billing data, which confirms to the vehicle's driver that the passenger can be billed. The billing data allows the driver to take the passenger to his destination.

In a second example, the data receiver 210 receives the token data after the passenger is taken to the passenger's destination. The billing data generator 220 generates billing data, which provides a basis for issuance of an invoice or a receipt in the vehicle, as described in further detail hereinbelow.

In a third example, the data receiver 210 receives the token data after the passenger is taken to the passenger's destination. The billing data generator 220 issues an invoice or a receipt for the passenger or his employer, and generates billing data, which confirms to the vehicle's driver that the passenger is billed.

In the third example, the billing is carried out on the server (or on a computer communicatively connected to the server), and the driver is notified on successful billing, using the billing data, as described in further detail hereinbelow.

That is to say that the billing data can include a confirmation that the passenger can be billed (as in the first example), data to be used for billing and invoicing the passenger in the vehicle (as in the second example), or a confirmation that the passenger is billed on the server (as in the third example), as describe in further detail hereinbelow.

Optionally, the data receiver 210 further receives fare data from the vehicle, and the billing data generator 220 uses the fare data, in addition to the token data, for generating the billing data.

The fare data may include data generated automatically in the vehicle (say by the vehicle's taximeter), data entered manually by the driver (say using a PDA), or both, as described in further detail hereinbelow.

Optionally, the data receiver 210 further receives GPS location data from the vehicle and the billing data generator 220 uses the GPS location data, in addition to the token data, for generating the billing data.

The apparatus 2000 further includes a server data communicator 230, in communication with the billing data generator 220.

The server data communicator 230 communicates the generated billing data to the remote vehicle, say through a cellular network, a satellite network, the internet, etc., or any combination thereof, as described in further detail hereinbelow.

Optionally, apparatus 2000 further includes a dispatching information generator, in communication with the server data communicator 230.

The dispatching information generator generates dispatching data, such as data which carries information about a passenger who waits for the driver to take him from a certain address, as described in further detail hereinbelow.

The server data communicator 230 communicates the dispatching data to the vehicle data communicator 120 installed in the vehicle, as described in further detail hereinabove. The vehicle data communicator 120 forwards the dispatching data to a PDA or to another computer device installed in the vehicle, which presents the dispatching data to the driver, as described in further detail hereinbelow.

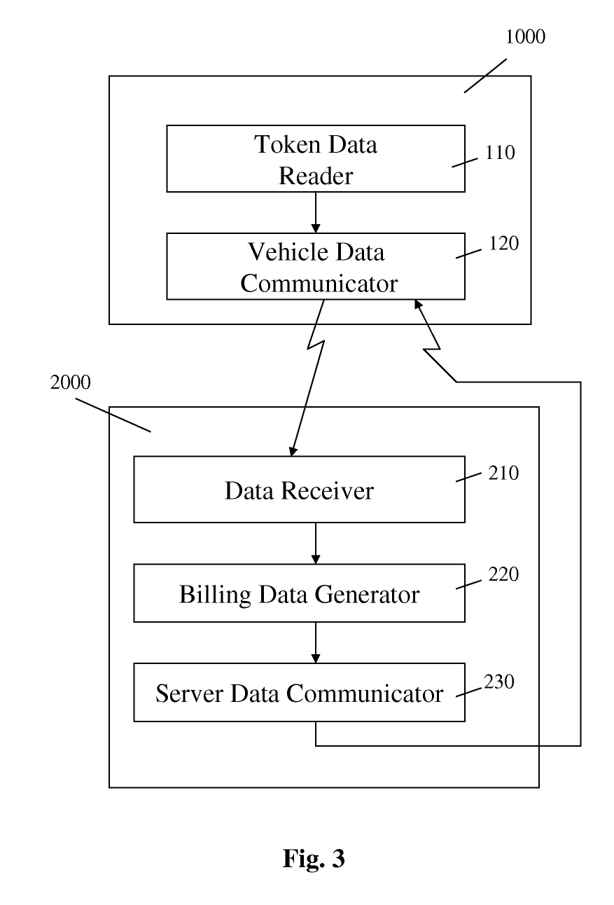

Reference is now made to FIG. 3, which is a block diagram, schematically illustrating a first system for taxi service controlling, according to an exemplary embodiment of the present invention.

A first exemplary system, according to an exemplary embodiment of the present invention, combines apparatus 1000 implemented on a vehicle of a fleet (say a taxi fleet), and apparatus 2000 implemented on a server of an operator of the fleet. The server is remote from the vehicle, as described in further detail hereinbelow.

The exemplary apparatus 1000 may be installed in each vehicle of the fleet.

The fleet may be used to provide a taxi service, as described in further detail hereinabove.

Apparatus 1000 includes a token data reader 110, installed in the vehicle.

The token data reader 110 may be implemented as hardware (say a magnetic card reader), as software, or as a combination of software and hardware, as described in further detail hereinabove.

The token data reader 110 reads token data from a machine readable medium provided by a passenger who boards the vehicle and wishes to be taken to a certain destination, as described in further detail hereinbelow.

Optionally, the token data is a secret PIN (Personal Identification Number), an encrypted number identifying the passenger or the passenger's employer, etc.

The machine readable medium may include, but is not limited to: a magnetic card imprinted with the token data, a smart card storing the token data in an encrypted format, a USB memory storing the token data in an encrypted format, a plastic card bearing the token data in a barcode format, a paper on which the token data is printed in a barcode format, etc.

Optionally, the machine readable medium is a card dispatched by a company to each of the company's employees.

Optionally, the machine readable medium is a card provided by a taxi service operator to a company which subscribes to the taxi service, and the company gives the card to a company employee or to an ad hoc user, as described in further detail hereinbelow.

Optionally, the machine readable medium is a prepaid card, as known in the art. In one example, the prepaid card is provided by a taxi service operator to a company which subscribes to the taxi service and the company dispatches the card to a company employee or to an ad hoc user, as described in further detail hereinbelow.

Optionally, the machine readable medium is a paper form given to the passenger by his employer, for a single use, and the token data is also limited to a single use.

Optionally, the token data identifies a subscriber of a taxi service (say a company the passenger works for, or the passenger himself), as described in further detail hereinbelow.

Optionally, the token data is a part of credit card data, say a PIN (Personal Identification Number) imprinted on a magnetic strip of a credit card, additional data imprinted on the magnetic strip, or both.

Apparatus 1000 further includes a vehicle data communicator 120, in communication with the token data reader 110.

The vehicle data communicator 120 communicates the read token data to a data receiver 210 of apparatus 2000 implemented on the server of the operator of the fleet, remote from the vehicle, as described in further detail hereinbelow.

Optionally, the vehicle data communicator 120 is implemented using a cellular modem, a satellite modem, or any other communication device usable for communicating data from the vehicle to the remote server.

The vehicle data communicator 120 may communicate the token data through one or more networks, including, but not limited to: the internet, a cellular network, a satellite network, etc., or any combination thereof.

The data receiver 210 receives the token data from the vehicle.

Optionally, the data receiver 210 is implemented using a cellular modem, a satellite modem, or any other communication device usable for receiving data communicated from the vehicle to the remote server.

Optionally, the token data identifies a subscriber of a taxi service (say a company the passenger works for, or the passenger himself), as described in further detail hereinbelow.

Apparatus 2000 further includes a billing data generator 220, in communication with the data receiver 210.

The billing data generator 220 generates billing data based at least on the received token data.

In one example, the data receiver 210 receives the token data before the passenger is taken to the passenger's destination. The billing data generator 220 verifies that the token data belongs to a subscriber of the taxi service, that the subscriber is not blocked due to credit problems, that the passenger's credit card is not blocked, etc.

Upon successful verification, the billing data generator 220 generates billing which is a confirmation to the vehicle's driver, that the passenger can be billed. The confirmation allows the driver to take the passenger to the passenger's destination.

In a second example, the data receiver 210 receives the token data after the passenger is taken to the passenger's destination. The billing data generator 220 generates billing data, which provides a basis for issuance of an invoice or a receipt in the vehicle, as described in further detail hereinbelow.

In a third example, the data receiver 210 receives the token data after the passenger is taken to the passenger's destination. The billing data generator 220 issues an invoice or a receipt for the passenger or his employer, and generates billing data which is a confirmation to the vehicle's driver, that the passenger is billed.

In the third example, the billing is carried out on the server (or on a computer communicatively connected to the server), and the driver is notified on the successful billing, using the billing data, as described in further detail hereinbelow.

That is to say that the billing data can include a confirmation that the passenger can be billed (as in the first example), data to be used for billing and invoicing the passenger in the vehicle (as in the second example), or a confirmation that the passenger is billed on the server (as in the third example), as describe in further detail hereinabove.

Optionally, the billing data is further based on information gathered in a preliminary stage, in which the passenger (or his employer) subscribes to the taxi service and provides information such as addresses, bank account details, etc., to the taxi service's operator, as described in further detail hereinbelow

Optionally, the apparatus 1000 further includes a taximeter.

The taximeter generates fare data, typically based on a combination of distance traveled and waiting time, as known in the art.

The vehicle data communicator 120 communicates the generated fare data together with the token data, to the data receiver 210.

The data receiver 210 receives the taximeter generated fare data from the vehicle, and the billing data generator 220 uses the taximeter generated fare data, in addition the token data, for generating the billing data.

Optionally, the apparatus 1000 further includes a computer unit, such as a PDA (Personal Digital Assist), and the vehicle's driver enters fare data to the computer unit.

The vehicle data communicator 120 communicates the fare data entered by the driver together with the token data, to the data receiver 210.

The data receiver 210 receives the driver entered fare data from the vehicle, and the billing data generator 220 uses the driver entered fare data, in addition the token data, for generating the billing data.

Optionally, the apparatus 1000 further includes a GPS receiver.

The GPS receiver generates GPS location data, based on signals transmitted by a GPS system, as known in the art.

The vehicle data communicator 120 communicates the generated GPS location data, together with the token data, to the data receiver 210.

The data receiver 210 receives the GPS location data from the vehicle, and the billing data generator 220 uses the GPS location data, in addition the token data, for generating the billing data.

Apparatus 2000 further includes a server data communicator 230, in communication with the billing data generator 220.

The server data communicator 230 communicates the generated billing data to the remote vehicle, say through a cellular network, a satellite network, the internet, etc., or any combination thereof, as described in further detail hereinabove.

The vehicle data communicator 120 receives the billing data based on the token data, from the remote server.

In one example, the billing data is a confirmation that the passenger can be billed, communicated to the vehicle data communicator 120, before the driver of the vehicle takes the passenger to the passenger's destination, as described in further detailed hereinbelow. Optionally, the vehicle data communicator 120 is connected to a green light. Upon receipt of the confirmation, the vehicle data communicator 120 informs the driver on the confirmation, by turning on the green light.

In a second example, the billing data provides a basis for issuance of an invoice or a receipt. Consequently, upon receipt of the billing data by the vehicle data communicator 120, an invoice or a receipt is printed in the vehicle, using a small printer installed in the vehicle, say a printer attached to the vehicle's taximeter, as described in further detail hereinbelow.

In a third example, the billing data is a confirmation that the passenger is billed on the server, communicated to the vehicle data communicator 120, after the driver of the vehicle arrives at the passenger's destination, as described in further detailed hereinbelow.

Optionally, the vehicle data communicator 120 is connected to a yellow light. Upon receipt of the confirmation, the vehicle data communicator 120 informs the driver on the confirmation, by turning on the yellow light.

Optionally, the exemplary first system further includes a dispatching information generator, implemented on the server 2000, in communication with the server data communicator 230.

The dispatching information generator generates dispatching data, say dispatching data which carries information about a passenger who waits for the driver to take him from a certain address, as described in further detail hereinbelow.

The server data communicator 230 communicates the dispatching data to the vehicle's data communicator 120. The vehicle data communicator 120 forwards the dispatching data to a PDA or to another computer device installed in the vehicle. The computer device presents the dispatching data to the driver, as described in further detail hereinbelow.

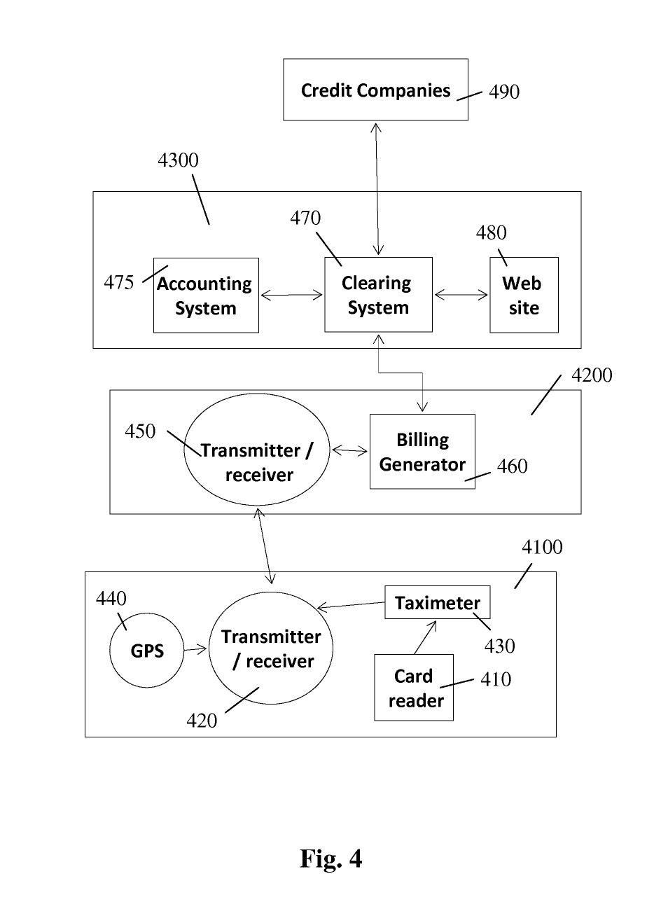

Reference is now made to FIG. 4, which is a block diagram, schematically illustrating a second system for taxi service controlling, according to an exemplary embodiment of the present invention.

A second system according to an exemplary embodiment of the present invention includes an apparatus 4100, implemented on a vehicle of a fleet.

The fleet may include taxicabs used by an operator of a taxi service, helicopters used by a helicopter taxi service operator, or any other fleet of vehicles used to carry passengers for a fare.

The apparatus 4100 includes a token data reader, say a card reader 410 such as a magnetic card reader, a barcode reader, etc.

The card reader 410 reads token data from a machine readable medium provided by a passenger who boards the vehicle and wishes to be taken to a certain destination.

Optionally, the token data is a secret PIN (Personal Identification Number), an encrypted number identifying the passenger or the passenger's employer, etc.

The machine readable medium may include, but is not limited to: a magnetic card imprinted with the token data, a smart card storing the token data in an encrypted format, a plastic card bearing the token data encrypted in a barcode format, etc.

Optionally, the machine readable medium is a card dispatched by a company to each of the company's employees.

Optionally, the machine readable medium is a card provided by a taxi service operator to a company which subscribes to the taxi service, and the company gives the card to a company employee or to an ad hoc user, as described in further detail hereinbelow.

Optionally, the machine readable medium is a prepaid card, as known in the art. In one example, the prepaid card is provided by a taxi service operator to a company which subscribes to the taxi service, and the company dispatches the card to a company employee or to an ad hoc user, as described in further detail hereinbelow.

Optionally, the token data identifies a subscriber of a taxi service (say a company the passenger works for, or the passenger himself), as described in further detail hereinbelow.

Optionally, the token data is a part of credit card data, say a PIN (Personal Identification Number) imprinted on a magnetic strip of a credit card, additional data imprinted on the magnetic strip, or both.

The apparatus 4100 further includes a taximeter 430, in communication with the card reader 410.

The taximeter 430 generates fare data, typically based on a combination of distance traveled by the vehicle and time in which the vehicle waits (say time the vehicle spends in traffic jams), as known in the art.

The apparatus 4100 further includes a GPS receiver 440.

The GPS receiver 440 generates GPS location data, based on signals transmitted by a GPS system and received by the GPS receiver 440, as described in further detail hereinbelow.

The apparatus 4100 further includes a vehicle data communicator, implemented as a cellular receiver/transmitter 420, in communication with the taximeter 430 and the GPS receiver 440.

The cellular receiver/transmitter 420 receives the fare data and the token data from the taximeter 430 and the card reader 410, as described in further detail hereinbelow.

The cellular receiver/transmitter 420 also receives the GPS location data from the GPS receiver 440.

The cellular receiver/transmitter 420 communicates the token data, fare data, and GPS location data to a data receiver implemented as a cellular receiver/transmitter 450, installed on a server 4200 remote from the vehicle.

Optionally, the server 4200 is a computer deployed at a central office of an operator of a taxi service, as described in further detail hereinabove.

The cellular receiver/transmitter 450, installed on the server 4200, forwards the token data, fare data, and GPS location data to a billing data generator 460 in communication with the server's 4200 cellular receiver/transmitter 450.

The billing data generator 460 generates billing data, based on the token data, the fare data, the GPS location data, or on a combination thereof, as described in further detail hereinabove.

In order to generate the billing data, the billing data generator 460 communicates with one or more systems implemented on a computer 4300, also referred to hereinbelow as a back office computer 4300.

On the back office computer 4300, there may be carried out back office activities, such as confirmation of taxi driver details, approval of a credit card transaction, using information provided by a credit card company or a credit card clearance service, etc. The back office activities may further include: billing processes for taxi service subscribers, generation of financial records for the billing, management of a driver's payment balance, issuance of invoices, issuance of receipts, generation of a periodic (say monthly) payment to drivers, generation of reports, etc.

More specifically, the billing data generator 460 communicates with a clearing system 470, which verifies that the token data is valid. For example, the clearing system 470 may verify that the token data belongs to a subscriber of the taxi service, that the subscriber is not blocked due to credit problems, that the passenger's credit card is not blocked, etc.

Optionally, the clearing system 470 verifies that the token data is valid, using information available on an accounting system 475 in communication with the clearing system 470, say information in the subscriber's credit account, as known in the art.

Optionally, the token data is a part of data imprinted on the passenger's credit card, and the clearing system 470 verifies that the token data is valid, using information available from credit card company computers 490 in communication with the clearing system 470.

In one example, when the passenger boards the vehicle, the driver slides the passenger's card (be it a credit card, a magnetic card issued to a subscriber of the taxi service, etc.), into the card reader 410.

Consequently, token data is read by the card reader 410 and communicated to the billing data generator 460, through the cellular transmitter/receivers 420, 450, as described in further detail hereinabove.

The billing data generator 460 verifies that the token data is valid, using the accounting system 475, the credit company computers 490, or both.

Upon successful verification of the token data's validity, the billing data generator 460 generates billing data which confirms that the passenger can be billed. The server's transmission/receiver 450 communicates the billing data to the transmitter/receiver 420 installed in the vehicle. The vehicle's transmitter/receiver 420 forwards the billing data to the taximeter 430, which signals to the driver, that the passenger can be taken to the passenger's destination, say using a green light, a beep, etc., as described in further detail hereinbelow.

Upon arrival of the vehicle at the destination, the driver slides the card into the card reader 410 again.

Consequently, the card reader 410 reads the token data again. The taximeter 430 forwards the token data and the fare data generated by the taximeter 430, to the vehicle's transmitter/receiver 420. The transmitter/receiver 420 communicates the token data, the fare data and the GPS location data generated by the GPS receiver 440, to the billing data generator 460, through the server's transmitter/receiver 450.

The billing data generator 460 generated billing data based on the token data, the fare data, the GPS location data, or any combination thereof, and records the billing data in the accounting system 475, using the clearing system 470.

Optionally, the server's transmitter/receiver 450 communicates the billing data to the vehicle's transmitter/receiver 420, which forwards the billing data to the taximeter 430. The taximeter 460 prints an invoice based on the billing data, using a small printer connected to the taximeter 460, as known in the art.

Optionally, the passenger (or an employer who employs the passenger, and is a subscriber of the taxi service) is rather invoiced by the clearing system 470. Consequently, an invoice is presented to the passenger on line (say on a web site 480 of the taxi service, as described in further detail hereinbelow), or sent by mail.

Then, the billing data generator 460 generates billing data which indicates that the passenger is billed. The server's transmitter/receiver 450 communicates the billing data to the vehicle's transmitter/receiver 420, which forwards the billing data to the taximeter 430. The taximeter 460 signals to the driver that the passenger is billed, say using a green light, a yellow light, a beep, etc., as described in further detail hereinbelow.

Optionally, the second system further includes a website 480, implemented on the back office computer 4300.

The website 480 may be used by a subscriber of the taxi service, an employee of a company subscribed to the taxi service, etc., for inputting a taxi order. Consequently, dispatching data based on the taxi order is sent to the vehicle of the taxi service operator's fleet, using the transmitter/receiver 450 on the server 4200.

The dispatching data sent to the vehicle, may include details such as: the company's name, origin, destination, number of passengers, number of stops, etc., as described in further detail hereinbelow.

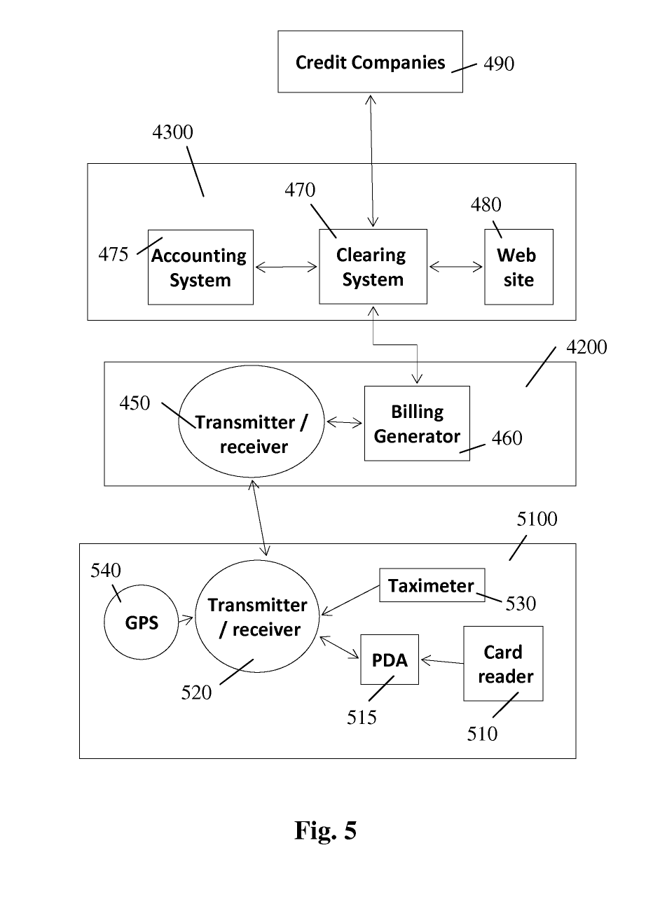

Reference is now made to FIG. 5, which is a block diagram, schematically illustrating a third system for taxi service controlling, according to an exemplary embodiment of the present invention.

A third system according to an exemplary embodiment of the present invention includes an apparatus 5100, implemented on a vehicle of a fleet.

The apparatus 4100 includes a token data reader, say a card reader 510 such as a magnetic card reader, a barcode reader, etc.

The card reader 510 reads token data from a machine readable medium provided by a passenger who boards the vehicle and wishes to be taken to a certain destination, as described in further detail hereinbelow.

Optionally, the machine readable medium is a card provided by a taxi service operator to a company which subscribes to the taxi service, and the company gives the card to a company employee or to an ad hoc user, as described in further detail hereinbelow.

Optionally, the machine readable medium is a prepaid card, as known in the art. In one example, the prepaid card is provided by a taxi service operator to a company which subscribes to the taxi service, and the company dispatches the card to a company employee or to an ad hoc user, as described in further detail hereinbelow.

Optionally, the token data is a secret PIN (Personal Identification Number), an encrypted number which identifies the passenger or the passenger's employer, etc., as described in further detail hereinabove.

Optionally, the token data identifies a subscriber of a taxi service (say a company the passenger works for, or the passenger himself), as described in further detail hereinbelow.

The apparatus 5100 further includes a PDA 515 (Personal Digital Assist) in communication with the card reader 510.

The PDA 515 is operable by the vehicle's driver, for manually entering fare data such as a fixed price, a discount, etc., to the PDA (say using a small keyboard).

Optionally, the apparatus 5100 further includes a taximeter 530.

The taximeter 530 generates fare data, typically based on a combination of distance traveled by the vehicle and time in which the vehicle waits (say time the vehicle spends in traffic jams), as known in the art.

The apparatus 5100 further includes a GPS receiver 540.

The GPS receiver 540 generates GPS location data, based on signals transmitted by a GPS system and received by the GPS receiver 540, as known in the art.

The apparatus 5100 further includes a vehicle data communicator, implemented as a cellular receiver/transmitter 520, in communication with the PDA 515, the taximeter 530, and the GPS receiver 540.

The cellular receiver/transmitter 520 receives the driver entered fare data and the token data from the PDA 515 and the card reader 510.

The cellular receiver/transmitter 420 also receives the GPS location data from the GPS receiver 440.

Optionally, the cellular receiver/transmitter 420 further receives the fare data generated by the taximeter 530.

The cellular receiver/transmitter 420 communicates the token data, the fare data (entered by the driver, generated by the taximeter 530, or both), and the GPS location data, to a data receiver implemented as a cellular receiver/transmitter 450.

The cellular receiver/transmitter 450 is installed on a server 4200 remote from the vehicle, say on a server 4200 of an operator of the taxi service and the taxi service's fleet, as described in further detail hereinbelow.

Consequently, the billing generator 460 generates billing based at least on the token data, using the clearing system 470, accounting system 475, credit company computers 490, etc., as described in further detail hereinabove.

The invoicing of the passenger or the passenger's employer (company, institution, or another individual) may be carried out using an invoice presented on the taxi service's web site 480, or using an invoice printed in the vehicle, as described in further detail hereinabove.

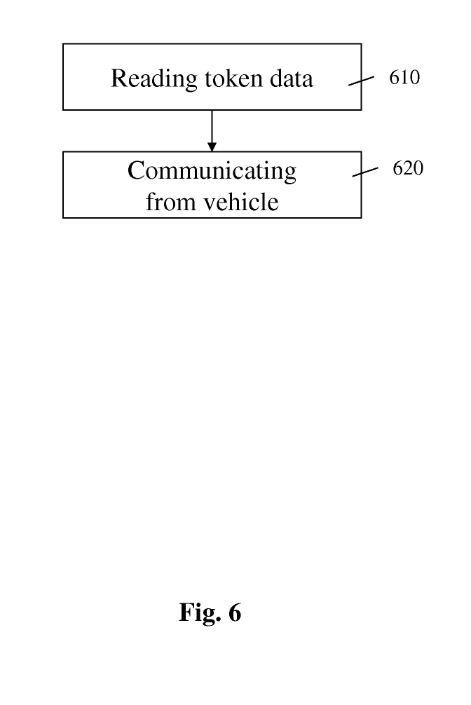

Reference is now made to FIG. 6, which is a flowchart illustrating a first method for taxi service controlling, according to an exemplary embodiment of the present invention.

A first exemplary computer implemented method for taxi service controlling, may be implemented in apparatus 1000, as described in further detail hereinabove.

The first exemplary method may thus be implemented in a vehicle of a fleet, say a taxi or any other vehicle used to carry passengers for a fare.

The first exemplary method includes steps a computer is programmed to perform.

In the first exemplary method, token data is read 610 from a machine readable medium provided by a passenger who boards the vehicle and wishes to be taken to a certain destination. Optionally, the token data is read 610 by the token data reader 110, as described in further detail hereinabove.

Optionally, the token data is a secret PIN (Personal Identification Number), an encrypted number identifying the passenger or the passenger's employer, etc.

The machine readable medium may include, but is not limited to: a magnetic card imprinted with the token data, a smart card storing the token data in an encrypted format, a USB memory storing the token data in an encrypted format, a plastic card bearing the token data in a barcode format, a paper on which the token data is printed in a barcode format, etc.

Optionally, the machine readable medium is a card dispatched by a company to each of the company's employees.

Optionally, the machine readable medium is a card provided by a taxi service operator to a company which subscribes to the taxi service, and the company gives the card to a company employee or to an ad hoc user, as described in further detail hereinbelow.

Optionally, the machine readable medium is a prepaid card, as known in the art. In one example, the prepaid card is provided by a taxi service operator to a company which subscribes to the taxi service, and the company dispatches the card to a company employee or to an ad hoc user, as described in further detail hereinbelow.

Optionally, the machine readable medium is a paper form given to the passenger by his employer, for a single use, and the token data is also limited to a single use.

Optionally, the token data identifies a subscriber of a taxi service (say a company the passenger works for, or the passenger himself), as described in further detail hereinbelow.

Optionally, the token data is a part of credit card data, say a PIN (Personal Identification Number) imprinted on a magnetic strip of a credit card, additional data imprinted on the magnetic strip, or both.

The read 610 token data is communicated 620 to a remote server of an operator of the fleet, say to a remote server in use by an operator of a taxi service, as described in further detail hereinbelow.

Optionally, the token data is communicated 620 by the vehicle data communicator 120 (say a cellular modem or a satellite modem), as described in further detail hereinabove.

The token data is used on the remote server, for generating billing data for the passenger (or the company the passenger works for).

Optionally, the billing data is based on the token data.

Optionally, the billing data is further based on information gathered in a preliminary stage, in which the passenger (or his employer) subscribes to the taxi service and provides information such as addresses, bank account details, etc., to the taxi service's operator, as described in further detail hereinbelow.

Finally, the billing data is received from the remote server, in the vehicle (say by the vehicle data communicator 120), as described in further detail hereinabove.

Optionally, the billing data provides a basis for issuance of an invoice or a receipt. Consequently, the invoice or receipt is printed in the vehicle, using a small printer installed in the vehicle, say a printer attached to the vehicle's taximeter, as described in further detail hereinbelow.

Optionally, the billing data is a confirmation that the passenger can be billed, which is sent from the server to the vehicle data communicator 120, before the vehicle takes the passenger to a destination, as described in further detail hereinbelow.

Optionally, the billing data is a confirmation that the passenger is billed by a system implemented on the remote server. The confirmation is sent from the remote server to the vehicle data communicator 120, after the vehicle arrives at the destination, as described in further detail hereinbelow.

Optionally, the first exemplary method further includes a step in which fare data is automatically generated, say by a taximeter, as described in further detail hereinabove. Typically, the taximeter generated fare data is based on a combination of distance traveled and waiting time, as known in the art.

The automatically generated fare data is communicated 620 to the remote server, together with the token data (say by the vehicle data communicator 120), as described in further detail hereinabove. Optionally, the billing data is further based on the automatically generated fare data.

Optionally, the first exemplary method further includes a step in which fare data is entered by the vehicle's driver, say using a computer unit such as a PDA, as described in further detail hereinbelow.

The driver entered fare data is communicated 620 to the remote server, together with the token data (say by the vehicle data communicator 120), as described in further detail hereinbelow. Optionally, the billing data is further based on the driver entered fare data.

Optionally, the first exemplary method further includes a step in which GPS location data is generated, say by a GPS receiver, as described in further detail hereinbelow. Typically, the GPS receiver generates the GPS location data, using signals transmitted from a GPS system, as known in the art.

The GPS location data is communicated 620 to the remote server, together with the token data (say by the vehicle data communicator 120), as described in further detail hereinbelow. Optionally, the billing data is further based on the GPS location data.

Optionally, the first exemplary method further includes receiving dispatching data from the remote server and presenting the dispatching data to the driver, say using a screen attached to the taximeter or a screen of a PDA (Personal Digital Assist), as described in further detail hereinbelow.

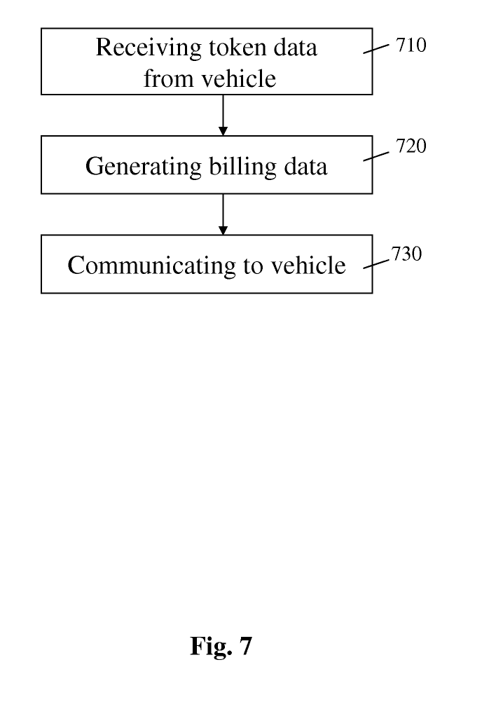

Reference is now made to FIG. 7, which is a flowchart illustrating a second method for taxi service controlling, according to an exemplary embodiment of the present invention.

A second exemplary computer implemented method for taxi service controlling, may be implemented in apparatus 2000, as described in further detail hereinabove.

The second exemplary method may thus be implemented on a server of an operator of a vehicle fleet, in remote communication with the vehicles of the fleet.

Optionally, the server is a computer installed at a central office of a taxi service operator, which communicates with one or more taxicabs used by the taxi service, for controlling the taxi service, as described in further detail hereinbelow.

The second exemplary method includes steps a computer is programmed to perform.

In the second exemplary method, token data is received 710 from a vehicle (say a taxicab) remote from the server, say by the data receiver 210, as described in further detail hereinabove.

Optionally, the token data is received 710 through one or more networks, including, but not limited to: the internet, a cellular network, a satellite network, etc., or any combination thereof.

Optionally, the token data is a secret PIN (Personal Identification Number), an encrypted number identifying a passenger in the vehicle or the passenger's employer, etc.

Optionally, the token data identifies a subscriber of a taxi service (say a company the passenger works for, or the passenger himself), as described in further detail hereinbelow.

Optionally, the token data includes data read from a machine readable medium, in the vehicle, using the token data reader 110, as described in further detail hereinabove.

Optionally, the token data may include a part of credit card data, say a PIN (Personal Identification Number) imprinted on a magnetic strip of a credit card, additional data imprinted on the magnetic strip, or both, as described in further detail hereinabove.

Then, there is generated 720 billing data based at least on the received 710 token data, say by the billing data generator 220, as described in further detail hereinabove.

In a first example, the token data is received 710 before the passenger is taken to the passenger's destination.

Before generation 720 of the billing data, there is carried out verification that the token data belongs to a subscriber of the taxi service, that the subscriber is not blocked due to credit problems, that the passenger's credit card is not blocked, etc. Upon successful verification, the billing data is generated 720.

In the first example, the billing is a confirmation to the vehicle's driver, that the passenger can be billed. The confirmation allows the driver to take the passenger to the his destination.

In a second example, the token data is received 710 after the passenger is taken to the passenger's destination. The generated 720 billing data provides a basis for issuance of an invoice or a receipt in the vehicle, as described in further detail hereinbelow.

In a third example, the token data is received 710 after the passenger is taken to the passenger's destination.

An invoice or a receipt for the passenger or his employer is issued on the server, and the billing data which is a confirmation to the vehicle's driver that the passenger is billed, is generated 720.

In the third example, the billing is carried out on the server (or on a computer communicatively connected to the server), and the driver is notified on successful billing, using the billing data, as described in further detail hereinabove.

That is to say that the billing data can include a confirmation that the passenger can be billed (as in the first example), data to be used for billing and invoicing the passenger in the vehicle (as in the second example), or a confirmation that the passenger is billed on the server (as in the third example), as describe in further detail hereinabove.

Optionally, there is further received 710 fare data from the vehicle, and the billing data is based on the fare data, in addition the token data.

The fare data may include data generated automatically in the vehicle (say by the taximeter), data entered manually by the driver (say using a PDA), or both, as described in further detail hereinbelow.

Optionally, there is further received 710 GPS location data from the vehicle, and the billing data is based on the GPS location data, in addition the token data, as described in further detail hereinbelow.

Finally, the generated billing data is communicated 730 to the remote vehicle, say using the server data communicator 230, as described in further detail hereinabove.

The generated billing data may be communicated 730 to the remote vehicle through a cellular network, a satellite network, the internet, etc., or any combination thereof, as described in further detail hereinabove.

Optionally, the second exemplary method further includes generating dispatching data, such as data which carries information about a passenger who waits for the driver to take him from a certain address, as described in further detail hereinbelow.

The dispatching data is communicated to the vehicle, as described in further detail hereinabove.

In the vehicle, the dispatching information is presented to the driver, say using a screen attached to the vehicle's taximeter, as described in further detail hereinabove.

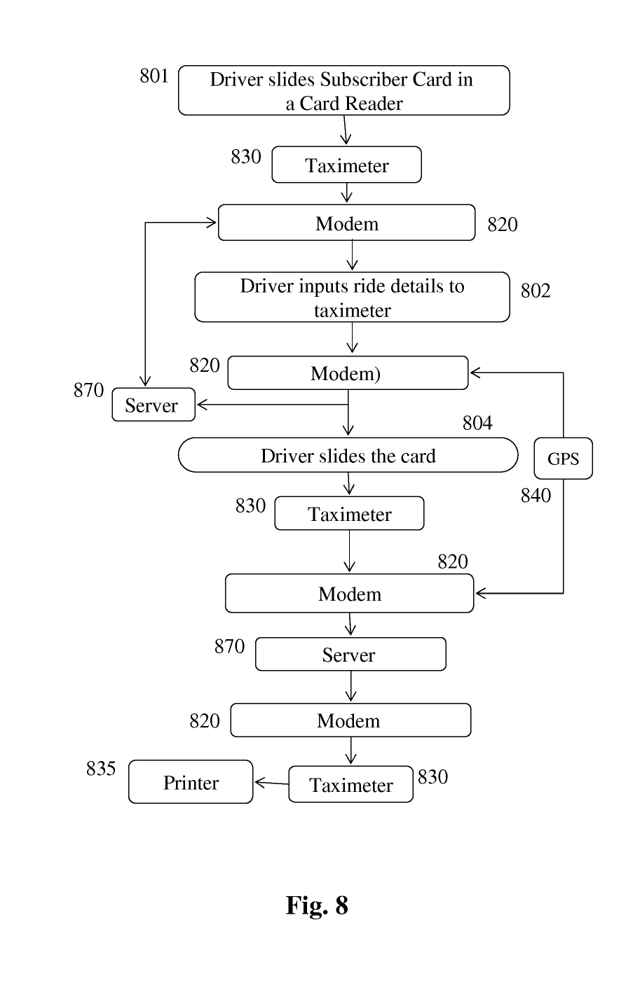

Reference is now made to FIG. 8, which is a flowchart illustrating a third method for taxi service controlling, according to an exemplary embodiment of the present invention.

According to an exemplary embodiment, a company or another institution subscribes to a taxi service.

The company receives from the operator of the taxi service magnetic cards.

Each of the cards is imprinted with token data, say with a secret PIN (Personal Identification Number), as described in further detail hereinabove.

Optionally, the token data is a company specific number, which identifies the company as a subscriber of the taxi service, and the company gives each of the cards to an employee or a visitor, for use on a regular or an ad hoc basis.

Optionally, the token data is a card specific number. The company distributes the cards to the company's employees. The company assigns each card to a specific employee. Consequently, the card specific number identifies the company's employee, as a subscriber of the taxi service.

In one example, an employee orders a taxi from the taxi service, say using a website, as described in further detail hereinabove.

When the employee boards a vehicle of the taxi service's vehicle fleet, the employee gives the magnetic card to the taxi driver. The taxi driver slides 801 the magnetic card into a token data reader, say a magnetic card reader, as described in further detail hereinabove.

The token data on the employees' card is read by the magnetic card reader, and forwarded to the vehicle's taximeter 830.

Then, the taximeter 830 forwards the token data to a vehicle data communicator such as a modem 820, installed in the vehicle.

Optionally, the modem 820 is a GPRS (General Packet Radio Service) cellular modem or a UMTS (Universal Mobile Telecommunications System) cellular modem, as known in the art.

The modem 820 communicates the token data to a remote server 870 in use by the operator of the taxi service and fleet.

On the remote server 870, the token data serves to identify the employee (or the company) as a subscriber of the taxi service, and to make sure that the employee or his company can be billed, as described in further detail hereinabove.

Consequently, billing data which confirms that the passenger (i.e. employee) can be billed is communicated from the remote server 870, to the vehicle's modem 820.

Upon receiving the billing data which confirms that the passenger can be billed, the confirmation in conveyed to the driver, say using a green light on the taximeter 830, a computer screen connected to the taximeter 830, etc.

However, the billing data may rather indicate that the passenger cannot be billed (say because of credit problems or because the token data is invalid). Upon receiving the billing data which indicates that the passenger cannot be billed, the driver is notified, say using a red light on the taximeter 830, a computer screen connected to the taximeter 830, etc.

Upon receiving billing data which confirms that the passenger can be billed, the driver inputs 802 fare data, say ride details to the taximeter 830.

The driver input ride details may include, but are not limited to: an indication that the ride is on a fixed price fare, an indication that the ride is on a fare to be calculated by the taximeter 830, destination, number of passengers or stops, etc.

Then, the modem 820 communicates the driver input fare data, from the taximeter 830 to the remote server 870.

Optionally, the modem further communicates to the remote server 870, fare data generated by the taximeter 830, such as a taxi identification number, a driver identification number, a taximeter serial number, etc.

Optionally, the modem 820 further communicates to the server 870, start-of-ride GPS location data, generated by a GPS receiver 840 installed in the vehicle, which indicates the location of the vehicle when the employee boards the vehicle.

Then, the driver drives the vehicle to the employee's destination.

Upon arrival at the destination, the taximeter 830 generates fare data for the vehicle's ride to the destination, as known in the art.

The driver slides 804 the card into the magnetic card reader again, and the token data is read and forwarded to the taximeter 830.

Then, the modem 820 communicates the taximeter generated fare data and the token data, from the taximeter 830 to the remote server 870.

Optionally, the modem 820 further communicates end-of-ride GPS location data, generated by a GPS receiver 840 installed in the vehicle, to the remote server 870. The end-of-ride GPS location data indicates the location of the vehicle, when the token data and taximeter generated fare data are communicated to the remote server 870 (i.e. when the vehicle arrives at the destination).

On the remote server 870, the fare data and the token data are used to generate billing data for the ride, say the final price, name of the party billed (say the company), etc.

Optionally, the GPS start-of-ride location data and the GPS end-of-ride location data are used to verify that the taximeter generated fare data is reasonable, in light of distance between the vehicle's locations.

Finally, the generated billing data is communicated from the server remote 870 to the vehicle's modem 820.

The modem 820 forwards the billing data to the taximeter 830, which prints an invoice, using a small printer 835 connected to the taximeter 830, as known in the art.

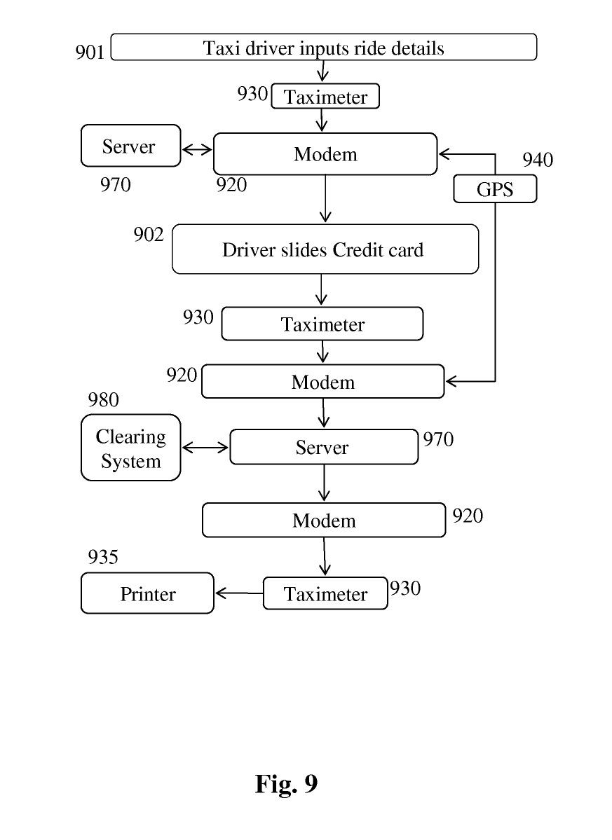

Reference is now made to FIG. 9, which is a flowchart illustrating a fourth method for taxi service controlling, according to an exemplary embodiment of the present invention.

In a fourth method, according to an exemplary embodiment of the present invention, a passenger boards a taxicab of a taxi service's fleet.

The taxicab's driver inputs 901 fare data to the taximeter 930. The fare data may include ride details, such as the passenger's destination, number of passengers or stops on the way, extra charges for luggage, etc.

Then, the taximeter 930 forwards the fare data to a vehicle data communicator such as a modem 920, installed in the vehicle.

Optionally, the modem 920 is a GPRS (General Packet Radio Service) cellular modem or a UMTS (Universal Mobile Telecommunications System) cellular modem, as known in the art.

The modem 920 communicates the fare data to a remote server 970 in use by the operator of the taxi service and fleet.

Optionally, the modem 920 further communicates to the remote server 970, start-of-ride GPS location data, generated by a GPS receiver 940 installed in the vehicle, which indicates the location of the vehicle when the employee boards the vehicle.

Then, the driver drives the vehicle to the employee's destination.

Upon arrival at the destination, the driver slides 902 the passenger's credit card into a token data reader, say a magnetic card reader installed in the vehicle. The token data is read by the magnetic card reader and forwarded to the taximeter 930.

The token data may include a PIN (Personal Identification Number) imprinted on a magnetic strip of a credit card, additional data imprinted on the magnetic strip, or both.

Further, upon the arrival of the vehicle to the destination, the taximeter 930 generates fare data for the vehicle's ride to the destination, as known in the art.

Then, the modem 920 communicates the taximeter generated fare data and the token data, from the taximeter 930 to the remote server 970.

Optionally, the modem 920 further communicates end-of-ride GPS location data, generated by a GPS receiver 940 installed in the vehicle, to the remote server 970. The end-of-ride GPS location data indicates the location of the vehicle when the token data and taximeter generated fare data are communicated to the remote server 970 (i.e. when the vehicle arrives at the destination).

On the remote server 970, the fare data and the token data are used to bill the passenger and charge the passenger's credit card, using a clearing system 980 in communication with credit company computers, as described in further detail hereinabove.

Optionally, the GPS start-of-ride location data and the GPS end-of-ride location data are used to verify that the taximeter generated fare data is reasonable, in light of distance between the vehicle's locations.

Finally, billing data confirming that the passenger is billed is generated on the remote computer 970 and communicated from the remote server 970 to the vehicle's modem 920, as described in further detail hereinabove.

The modem 920 forwards the billing data to the taximeter 930, which prints a receipt, using a small printer 935 connected to the taximeter 930, as known in the art.

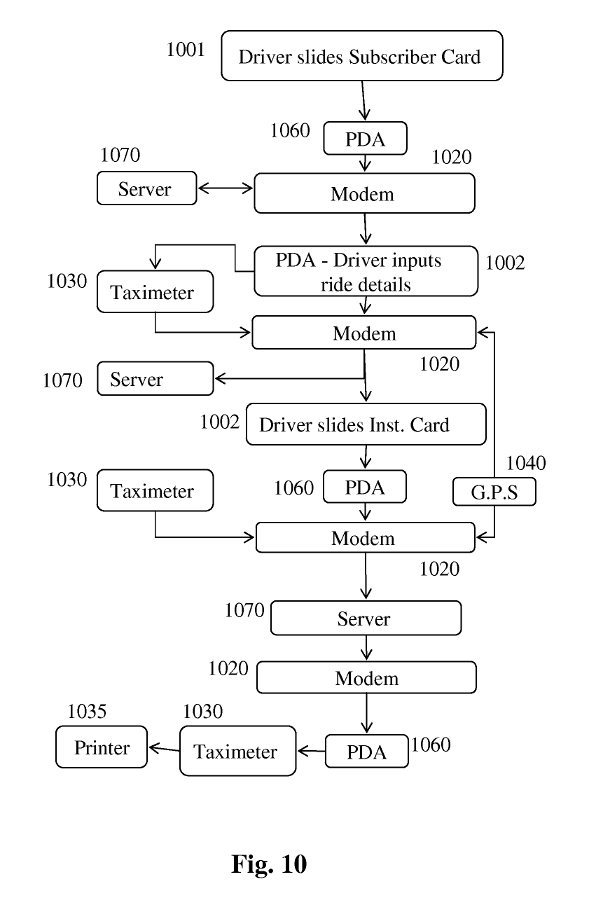

Reference is now made to FIG. 10, which is a flowchart illustrating a fifth method for taxi service controlling, according to an exemplary embodiment of the present invention.

According to an exemplary embodiment, a company or another institution subscribes to a taxi service.

The company receives from the operator of the taxi service magnetic cards.

Each of the cards is imprinted with token data, say with a secret PIN (Personal Identification Number).

Optionally, the token data is a company specific number, which identifies the company as a subscriber of the taxi service, and the company gives each of the cards to an employee or a visitor, for use on a regular or an ad hoc basis.

Optionally, the token data is a card specific number. The company distributes the cards to the company's employees. The company assigns each card to a specific employee. Consequently, the card specific number identifies the company's employee, as a subscriber of the taxi service.

In one example, an employee orders a taxi from the taxi service, say using a website, as described in further detail hereinabove.

When the employee boards a vehicle of the taxi service's vehicle fleet, the employee gives the magnetic card to the taxi driver. The taxi driver slides 1001 the magnetic card into a token data reader, say a magnetic card reader, as described in further detail hereinabove.

The token data on the employee's card is read by the magnetic card reader, and forwarded to a computer unit, say a PDA (Personal Digital Assist) 1060, as known in the art

Then, the PDA 1060 forwards the token data to a vehicle data communicator, such as a modem 1020 installed in the vehicle.

Optionally, the modem 1020 is a GPRS (General Packet Radio Service) cellular modem or a UMTS (Universal Mobile Telecommunications System) cellular modem, as known in the art.

The modem 1020 communicates the token data to a remote server 1070 in use by the operator of the taxi service and fleet.

On the remote server 1070, the token data serves to identify the employee (or the company), as a subscriber of the taxi service. Consequently, billing data which confirms that the passenger (i.e. employee) can be billed is communicated from the remote server 1070, to the vehicle's modem 1020.

Upon receiving the billing data which confirms that the passenger can be billed, the confirmation in conveyed to the driver, say using a message presented on the PDA's 1060 screen.

Then, the driver enters 1002 fare data, say ride details to the PDA 1060.

The ride details may include, but are not limited to: the passenger's destination, number of passengers or stops on the way, extra charges for luggage, an indication that the ride is on a fixed price fare, an indication that the ride on a fare to be calculated by a taximeter 1030 installed in the vehicle, etc.

Optionally, some of the ride details are forwarded by the PDA 1060 to the taximeter 1030, say the extra charges or the indication that the ride is on a fare to be calculated by the taximeter 1030.

Then, the modem 1020 communicates the driver entered fare data, from the PDA 1060, to the remote server 1070.

Optionally, the modem 1020 further communicates fare data which originates from the taximeter 1030 (say a number identifying the vehicle or the driver, a number identifying the taximeter 1030, etc.), from the taximeter 1030, to the remote server 1070.

Optionally, the modem 1020 further communicates to the server 1070, start-of-ride GPS location data, generated by a GPS receiver 1040 installed in the vehicle, which indicates the location of the vehicle when the employee boards the vehicle.

Then, the driver drives the vehicle to the employee's destination.

Upon arrival at the destination, the driver slides 1002 the card into the magnetic card reader again, and the token data is read and forwarded to the PDA 1060.

Optionally, upon the arrival to the destination, the taximeter 1030 generates fare data for the vehicle's ride to the destination, as known in the art.

The modem 1020 communicates the taximeter generated fare data, the token data, or both, to the remote server 1070.

Optionally, the modem 1020 further communicates end-of-ride GPS location data, generated by a GPS receiver 1040 installed in the vehicle, to the remote server 1070. The end-of-ride GPS location data indicates the location of the vehicle when the token data and taximeter generated fare data are communicated to the remote server 1070 (i.e. when the vehicle arrives at the destination).

On the remote server 1070, the fare data and the token data are used to generate billing data for the ride, say the final price, name of the party billed (say the company), etc.

Optionally, the GPS start-of-ride location data and the GPS end-of-ride location data are used to verify that the taximeter generated fare data is reasonable, in light of distance between the vehicle's locations.

Finally, the generated billing data is communicated from the server 1070 to the vehicle's modem 1020.

The modem 1020 forwards the billing data to the PDA 1060, which prints an invoice, using a small printer 1035 connected to the taximeter 1030, as known in the art.

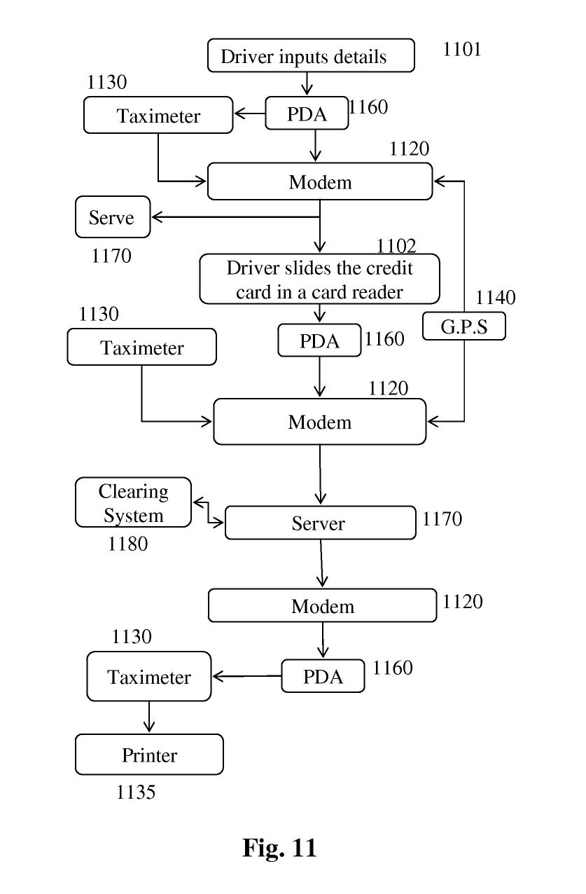

Reference is now made to FIG. 11, which is a flowchart illustrating a sixth method for taxi service controlling, according to an exemplary embodiment of the present invention.

In a sixth method, according to an exemplary embodiment of the present invention, a passenger boards a taxicab. The taxicab is one vehicle of a fleet of vehicles operated by a taxi service operator.

The taxicab's driver inputs 1101 fare data, say ride details, to a PDA 1160 installed in the taxicab.

The ride details may include, but are not limited to details such as the passenger's destination, the number of passengers or stops on the way, extra charges for luggage, an indication that the ride is on a fixed price fare, an indication that the ride on a fare to be calculated by a taximeter 1130 installed in the taxicab, etc., as described in further detail hereinabove.

Optionally, some of the ride details are forwarded by the PDA 1160 to the taximeter 1130, say the extra charges or the indication that the ride is on a fare to be calculated by the taximeter 1130.

Then, a vehicle data communicator, say a cellular modem 1120 installed in the taxicab, communicates the driver entered fare data, from the PDA 1160, to a remote server 1170 of the operator of the taxi service and fleet.

Optionally, the modem 1120 further communicates fare data which originates from the taximeter 1130 (say a number identifying the taxicab or the driver, a number identifying the taximeter 1130, etc.), from the taximeter 1130, to the remote server 1170.

Optionally, the modem 1120 further communicates to the remote server 1170, start-of-ride GPS location data, generated by a GPS receiver 1140 installed in the taxicab, which indicates the location of the taxicab, when the employee boards the taxicab.

Then, the driver drives the taxicab to the employee's destination.

Upon arrival at the destination, the driver slides 1102 the passenger's credit card into a magnetic card reader, and token data on the credit card is read by the magnetic card reader, and forwarded to the PDA 1160, as described in further detail hereinabove.

The modem 1120 communicates the token data to the remote server 1070.

Optionally, upon the arrival to the destination, the taximeter 1130 generates fare data for the taxicab's ride to the destination, as known in the art. The modem 1120 further communicates the taximeter generated fare data to the remote server 1170.

Optionally, the modem 1120 further communicates end-of-ride GPS location data, generated by a GPS receiver 1140 installed in the taxicab to the remote server 1170. The end-of-ride GPS location data indicates the location of the taxicab when the token data and taximeter generated fare data are communicated to the remote server 1170 (i.e. when the taxicab arrives at the destination).

On the remote server 1170, the fare data and the token data are used to bill the passenger and charge the passenger's credit card, using a clearing system 1180 in communication with credit company computers, as described in further detail hereinabove.

Optionally, the GPS start-of-ride location data and the GPS end-of-ride location data are used to verify that the taximeter generated fare data is reasonable, in light of distance between the taxicab's locations.

Finally, billing data confirming that the passenger is billed is generated on the remote computer 1170 and communicated from the server 1170 to the taxicab's modem 1120, as described in further detail hereinabove.

The modem 1120 forwards the billing data to the PDA 1160, which prints a receipt, using a small printer 1135 connected to the taximeter 1130, as known in the art.

It is expected that during the life of this patent many relevant devices and systems will be developed and the scope of the terms herein, particularly of the terms “Computer”, “PDA”, “Taximeter”, “Card Reader”, “Magnetic Card Reader”, “Magnetic Card”, “Smart Card”, “Prepaid Card”, “Modem”, “Cellular Modem”, “Transmitter/Receiver” and “Server”, is intended to include all such new technologies a priori

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for taxi service controlling, the apparatus comprising:
a token data reader, installed in a vehicle of a fleet, configured to read token data from a machine readable medium provided by a passenger; and
a vehicle data communicator, in communication with said token data reader, configured to communicate the read token data to a remote server of an operator of the fleet, and to receive billing data based at least on the token data, from the remote server.

2. The apparatus of claim 1, wherein the token data identifies a subscriber of the taxi service.

3. The apparatus of claim 1, wherein the machine readable medium is a smart card.

4. The apparatus of claim 1, wherein the machine readable medium is a magnetic card.

5. The apparatus of claim 1, wherein the token data is formatted as a barcode.

6. The apparatus of claim 1, further comprising a taximeter, configured to generate fare data, wherein said vehicle data communicator is further configured to communicate the fare data to the remote server, and the received billing data is further based on the fare data.

7. The apparatus of claim 1, further comprising a computer unit configured to receive fare data from a driver of the vehicle, wherein said vehicle data communicator is further configured to communicate the fare data to the remote server server, and the received billing data is further based on the fare data.

8. The apparatus of claim 7, wherein said computer unit is a PDA (Personal Digital Assist).

9. The apparatus of claim 1, further comprising a GPS receiver, configured to generate GPS location data on the vehicle, wherein said vehicle data communicator is further configured to communicate the GPS location data to the remote server, and the received billing data is further based on the GPS location data.

10. The apparatus of claim 1, wherein the token data is a part of credit card data.

11. The apparatus of claim 1, wherein the billing data is a confirmation that the passenger can be billed or that the passenger is billed.

12. A computer implemented method for taxi service controlling, the method comprising steps the computer is programmed to perform, the steps comprising:
in a vehicle of a fleet, reading token data from a machine readable medium provided by a passenger;
communicating the read token data to a remote server of an operator of the fleet; and
receiving billing data based at least on the token data, from the remote server.

13. The method of claim 12, wherein the token data identifies a subscriber of the taxi service.

14. The method of claim 12, further comprising automatically generating fare data, and communicating the generated fare data to the remote server, wherein the received billing data is further based on the fare data.

15. The method of claim 12, further comprising receiving fare data from a driver of the vehicle, and communicating the received fare data to the remote server, wherein the received billing data is further based on the fare data.

16. The method of claim 12, further comprising generating GPS location data on the vehicle, and communicating the GPS location data to the remote server, wherein the received billing data is further based on the GPS location data.

17. The method of claim 12, wherein the token data is a part of credit card data.

18. The method of claim 12, wherein the billing data is a confirmation that the passenger can be billed or that the passenger is billed.

19. An apparatus for taxi service controlling, implemented on a server of an operator of a vehicle fleet, the apparatus comprising:
a data receiver, configured to receive token data of a passenger from a vehicle remote from the server of the vehicle fleet;
a billing data generator, in communication with said data receiver, configured to generate billing data based at least on the received token data; and
a server data communicator, in communication with said billing data generator, configured to communicate the generated billing data to the vehicle remote from the server.

20. The apparatus of claim 19, wherein the token data identifies a subscriber of the taxi service.

21. The apparatus of claim 19, wherein said data receiver is further configured to receive fare data from the vehicle and said billing data generator is further configured to use the fare data in generating the billing data.

22. The apparatus of claim 19, wherein said data receiver is further configured to receive GPS location data from the vehicle and said billing data generator is further configured to use the received GPS location data in generating the billing data.

23. A method for taxi service controlling, implemented on a server of an operator of a vehicle fleet, the method comprising steps the server is programmed to perform, the steps comprising:
receiving token data of a passenger from a vehicle remote from the server of the operator of the vehicle fleet;
generating billing data based at least on the received token data; and
communicating the generated billing data to the vehicle remote from the server.

24. The method of claim 23, wherein the token data identifies a subscriber of the taxi service.

25. The method of claim 23, further comprising receiving fare data from the vehicle, and using the fare data in said generating the billing data.

26. The method of claim 23, further comprising receiving GPS location data from the vehicle, and using the GPS location data in said generating the billing data.

27. A system for taxi service controlling, the system comprising:
a token data reader, installed in a vehicle of a fleet, configured to read token data from a machine readable medium provided by a passenger;
a vehicle data communicator, in communication with said token data reader, for receiving the read token data;
a data receiver, implemented on a server of an operator of the fleet, in remote communication with said vehicle data communicator, for receiving the token data;
a billing data generator, configured to generate billing data, based at least on the received token data; and
a server data communicator, configured to communicate the generated billing data to said vehicle data communicator.

28. The system of claim 27, wherein the token data identifies a subscriber of the taxi service.
